(19) United States
(12) Patent Application Publication
(10) Pub. No.: US 2020/0214265 A1
(43) Pub. Date: Jul. 9, 2020

(54) METHOD AND SYSTEM FOR MONITORING THE GROWTH OF CALVES AND PIGLETS

(71) Applicant: Nedap N.V., Groenlo (NL)

(72) Inventors: Jort Johannes Wilhelmus Schutte, Nieuw Heeten (NL); Roxie Sabri Romero Muller, Enschede (NL)

(73) Assignee: Nedap N.V., Groenlo (NL)

(21) Appl. No.: 16/628,281

(22) PCT Filed: Mar. 1, 2018
(86) PCT No.: PCT/NL2018/050129

§ 371 Date: Jan. 3, 2020

(30) Foreign Application Priority Data
Jul. 5, 2017 (NL) 2019176

(51) Int. Cl. A01K 29/00; A01K 1/03; A01K 11/00; G06K 9/00; H04N 13/204; G06T 7/62

(52) U.S. Cl. CPC A01K 29/005; A01K 1/031; A01K 11/006; G06K 9/00335; H04N 13/204; G06T 7/62; G06K 9/0063; G06K 9/00201

(57) ABSTRACT

Method and systems for monitoring the growth of animals, comprising: a. bringing together animals in at least one space where they can freely move; b. obtaining a 3D image of an area within the at least one space with at least one 3D camera and/or a multiplicity of 2D cameras; c. supplying 3D information of the space to a signal processing unit; d. with a first predetermined algorithm, recognizing an animal in the 3D image; e. determining the identity of the animal; f. with the signal processing unit, according to a second predetermined algorithm, estimating a growth parameter of the animal recognized in step d.; g. repeating steps d.-f. when the animal appears in the image again; h. with the aid of computer collecting the information obtained in steps d.-g. to obtain insight into the growth of the animal over time.

### BACKGROUND OF THE INVENTION

The invention relates to a method and system for monitoring the development of animals in time, such as monitoring the growth of animals. In particular, this is about farm animals such as calves and piglets. In particular, the invention relates to the monitoring of a multiplicity of animals in a collective space such as a pen or barn space.

Growth of an animal such as a calf is crucial in calf rearing. Especially in the first three months of life, nothing is left undone to initiate the proper growth curve. Accordingly, the growth of a calf is closely watched by stock farmers. There are various known methods by which a farmer monitors the growth of a calf. Typically, known methods comprise physically separating a calf from other calves and weighing the calf using scales. On the scales, usually, only the front part of the body is weighed. The farmer then compares the weight of the previous measurement with the new measurement and derives from this a particular growth of the calf. The farmer then concludes on the basis of the determined growth whether the calf is growing as desired, or that there is stagnation or other deviation in growth. Such methods are particularly time intensive and have to be performed individually by the farmer. Data points in respect of growth that are collected by the farmer are sometimes not sufficiently frequent when the farmer keeps large numbers of calves. Further, the data points collected may contain measuring inaccuracies which are in or around the same order of magnitude as the measured growth. Especially the first eight weeks after birth of the calf, and in particular the first two weeks, are decisive for the growth of a calf. It may happen that stagnation of growth of a calf is recognized later than the (part of a) day when the stagnation of growth occurs. This may then have adverse consequences for the future growth and the welfare of the calf. A similar thing applies to other farm animals such as piglets.

Further, also when an animal is adult, it is important to follow the development of an animal in time. In this manner, for example, defects and diseases can be found in the animals.

### SUMMARY OF THE INVENTION

It is an object of the invention to provide a method and a system whereby a farmer is enabled to determine the development in time such as growth, accurately and efficiently, that is, relatively little labor-intensively. This makes it possible to intervene in a timely manner, for example in the nutrition of an animal such as a calf or piglet, in a critical period of the development of the animal. It is further an object of the invention to offer a farmer accurate insight into the development in time of the animal, such as the growth of the animal. It is further also an object to provide an ameliorated method and system for monitoring the development in time of an animal (such as a calf or piglet) in the presence of a group of such animals.

To this end, the invention provides a method and systems. By virtue of the steps a.-f., animals do not need to be individually measured or weighed. The method further comprises step g. in which the steps d.-f. are repeated when the animal appears in the image again. As a result, a large number of measurements can be done within a relatively short period of time. The method further comprises also the step h. to gain insight into the development of the animal in time, such as the growth of the animal.

Optionally, the collected information is, preferably with the first computer, compared with a predetermined development curve of the animal such as a growth curve. The development curve relates, for example, to a development of a condition parameter of an animal in time, such as a weight parameter, volume parameter or length parameter of the animal or of a weight parameter, volume parameter or length parameter of a part of the body of the animal, such as the torso. A length parameter relates, for example, to a length, height or width of the animal or of a part of the body of the animal. The development curve can cover, for example, the entire life of the animal or the period of the animal where it is adult or a period of the animal where it is still growing until the animal is full-grown. The growth curve relates, for example, to a development of a growth parameter of an animal in time. The growth parameter is for example a weight parameter, volume parameter and/or length parameter of the animal or of a part of the body of the animal, such as the torso. A length parameter, for example, again relates to a length, height or width of the animal or of a part of the body of the animal.

The growth curve can cover, for example, the first weeks and/or months after birth of an animal. Optionally, the predetermined growth curve is a minimum expected growth curve of a healthy animal. Preferably, with the first computer, an attention signal is generated when the collected information deviates from the development curve such as the growth curve, for example when such deviation meets a predetermined criterion.

Optionally, a predetermined criterion is that the deviation is greater than an acceptable difference (such as 5%, 10%, 15%, 20% or 25%) between collected information and the development curve such as the growth curve at a corresponding point in time. The deviation can reflect an extent of lag in development of the animal. An advantage is that deviating developments can be noticed. In particular, it holds that the first computer is so configured that an attention signal is generated when the animal information collected in time (which represents the development of the animal in time) deviates relative to the development curve, more particularly, that the first computer is so configured that an attention signal is generated when a growth of the animal lags behind the growth curve.

The attention signal is generated, for example, when an estimated growth parameter at a point in time is lower than a same growth parameter according to the predetermined growth curve at a corresponding point in time. Also, or instead, the attention signal may be generated, for example, when the change of an estimated growth parameter at a particular point in time is lower than the change of a same growth parameter according to the predetermined growth curve at a corresponding point in time. A change of an estimated growth parameter can be determined, for example, by comparing an estimated growth parameter with a previously estimated growth parameter.

Optionally, the attention signal comprises the identity determined in step e.

Optionally, step e. is carried out with a reader for wirelessly reading out the tags, the animals being each provided with a tag which comprises information about an identity of an animal. The reader and the tag are preferably of the RFID and/or UHF type. An RFID tag is a passive tag, known per se, which obtains its energy from the interrogation field which is emitted by the (RFID) reader. A UHF tag is provided with a transmitter which transmits on the UHF band to transfer information to the reader and to that end is provided with its own energy source such as a battery.

Optionally, the reader is so disposed that in step e. the identity of an animal is determined which is at such a position in the image that this animal in step d. is recognized in the image.

Optionally, in step b. the area comprises just a part of the at least one space where the animals can be.

Optionally, the area has such dimensions that a multiplicity of animals may be in it at the same time. Preferably, the area has a surface area which is in the range of 10-400 m2, in particular 15-100 m2.

Optionally, it holds that the area has such dimensions that A animals may be in it at the same time, with A being in the range of 1-10,000, in particular 1-1,000, more particularly 1-100, and still more particularly 1-50.

Optionally, with the at least one 3D camera and/or the multiplicity of cameras respectively areas of a multiplicity of spaces such as pens are covered.

Optionally, the signal processing unit is part of the first computer, while optionally the signal processing unit and/or the first computer are in a cloud.

Optionally, each animal is furthermore provided with at least one sensor for determining the behavior of the animal of which in step e. the identity has been determined, the behavior comprising, for example, a condition, such as walking, lying, eating and ruminating. The behavior may further comprise information about when particular conditions occur spread in time. The information obtained with the at least one sensor about the behavior of the animal may be used by a farmer in an analysis of the animal in combination with the information collected in step h with reference to the predetermined growth curve.

Optionally, the information about the behavior of the animal obtained with the sensors is used to adjust the predetermined criterion, for example such that underweight of the animal is detected at a smaller deviation when it already appears earlier from the determined behavior that the animal eats relatively little, or less often, and vice versa.

Optionally, the system according to the invention further includes at least one identification unit such as a reader for carrying out step e. The reader is preferably an RFID reader and/or UHF reader. Preferably, the system also includes a tag of a type that can be read out by the reader concerned so that the identity of an animal can be determined with the reader. Optionally, the first computer of the system is configured to compare the collected information with a predetermined development curve such as a growth curve. The first computer is further configured to generate an attention signal when the collected information deviates from the development curve such as the growth curve, with the deviation meeting a predetermined criterion.

Optionally, the first computer is so configured that an attention signal is generated when a growth of the animal lags behind the growth curve.

Optionally, the attention signal comprises the identity determined with the identification unit. The attention signal can take diverse forms such as an electronic signal, a wireless transmitter signal, an audio signal and a visible signal.

Optionally, the identification unit comprises a reader. The system may furthermore include a multiplicity of tags, the animals being each provided with a tag which comprises information about an identity of an animal. The reader and the multiplicity of tags are preferably of the RFID and/or UHF type.

Optionally, the identification unit is so disposed that, in use, the identity of an animal is determined when it is at such a position in the image that this animal is recognized in the image with the signal processing means, in use.

Optionally, the 3D camera and/or the multiplicity of cameras are so configured and/or disposed that, in use, the area comprises only a part of the at least one space where the animals can be in the pen.

Optionally, the area of the system has such dimensions that a multiplicity of animals may be present in it at the same time while, preferably, the area has a surface area which is in the range of 10-400 m2, in particular 15-100 m2.

Optionally, it holds that the area has such dimensions that A animals may be in it at the same time, with A being in the range of 1-10,000, in particular 1-1,000, more particularly 1-100, still more particularly 1-50.

Optionally, the at least one 3D camera and/or the multiplicity of cameras are so disposed that respectively a multiplicity of spaces such as a multiplicity of pens is covered.

Optionally, the signal processing unit is part of the first computer. Optionally, the signal processing unit and/or the first computer are in a cloud.

Optionally, the system furthermore includes sensors, while, in use, each animal is furthermore provided with at least one of the sensors for determining the behavior of the animal, the behavior concerning, for example, a condition which the animal is in, such as walking, lying, eating and/or ruminating, and/or information about when particular conditions occur spread in time. The at least one sensor is, for example, a motion sensor. The first computer is further configured for, in use, utilizing the information about the behavior of the animal obtained with the sensors in comparing the collected information with the predetermined development curve such as the growth curve.

Optionally, the first computer is configured for, in use, utilizing the information about the behavior of the animal obtained with the at least one sensor to adjust the predetermined criterion, for example such that, in use, underweight of the animal is detected at a smaller deviation when it already appears earlier from the determined behavior that the animal eats relatively little, or less often, and vice versa.

### DESCRIPTION OF THE DRAWINGS

The invention will be further clarified with reference to the drawing. The detailed description provides examples of possible modes of use of the invention. These modes of use should not be considered to be the only possible embodiments that fall under the ambit of the invention. The scope of the invention is defined in the claims, and the description should be regarded as being illustrative without thereby limiting the invention.

FIG. 1 shows a schematic system for monitoring the development in time of animals, such as growth of animals;

FIG. 2 shows a further schematic system for monitoring the development in time of animals such as growth of animals;

FIG. 3 shows a further schematic system for monitoring the development in time of animals such as growth of animals; and

FIG. 4 shows a schematic method for monitoring the development in time of animals such as growth of animals.

### DETAILED DESCRIPTION OF THE INVENTION

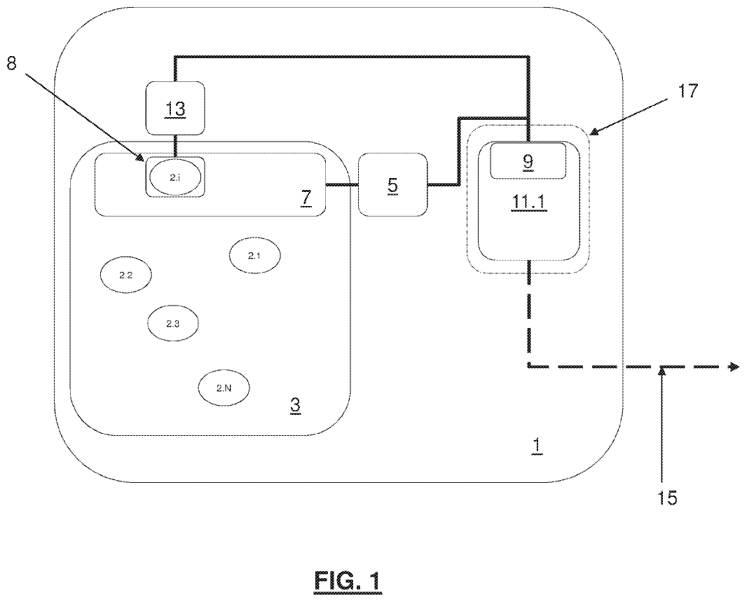

FIG. 1 shows a schematic system 1 for monitoring the development in time of animals such as growth of animals, in this example calves 2.i. The system 1 comprises at least one space such as a pen 3 in which a multiplicity of calves 2.i (i=1, 2, 3, . . . , N) can be gathered together. The system 1 further comprises a camera system 5 for forming a 3D image of an area 7 in the pen 3 where the calves 2.i can be. The camera system 5 in this example is a 3D camera, such as a stereo camera, but can also be a multiplicity of 2D cameras, each with its own housing, which can together constitute the 3D image. The camera system 5 can optionally also comprise a combination of the 3D camera and the multiplicity of 2D cameras. The system 1 additionally comprises also a signal processing unit 9 for processing information about the 3D image of the area 7. The signal processing unit 9 is configured to recognize, according to a first predetermined algorithm, a calf 2.i in the 3D image of the area 7, as at a position 8 in the 3D image of the area 7. The system 1 further comprises an identification unit 13 configured to determine an identity of the calf 2.i which has been recognized by the signal processing unit 9, as at the position 8 which may be predetermined. In this example, the identification unit 13 is implemented as a reader, such as an RFID reader or UHF reader. The system 1 additionally comprises a multiplicity of tags (not represented, but conventional), such as RFID tags or UHF tags. The calves 2.i are each provided with a tag of this multiplicity of tags. Each tag comprises information about the identity of a corresponding calf. The signal processing unit 9 is further configured for, on the basis of an obtained 3D image of the recognized calf 2.i, within the obtained 3D image of the area 7, according to a second predetermined algorithm, estimating at least one condition parameter, in this example a growth parameter of the recognized calf 2.i. The at least one growth parameter in this example is a weight of the calf 2.i, but this may additionally, or instead, also be a volume parameter or a length parameter. A length parameter represents, for example, a length or width or height of the calf 2.1. It will be clear that the second algorithm may also be designed to estimate length and/or volume parameters on the basis of the projection of the calf 2.i in the obtained 3D image of the area 7. This may then be instead of, or in combination with, determining the weight. The weight of the calf 2.i can then be derived from measured length and/or volume parameters of the calf, which are then combined with a predetermined density relation for obtaining a weight of the calf.

The system 1 furthermore comprises a first computer 11.1 configured to collect, at different points in time, information obtained about the at least one growth parameter of the identified recognized calf 2.i, so as to obtain insight into the growth of the recognized calf 2.i in time. In this example, the signal processing unit 9 is part of the first computer 11.1, but this is entirely optional. The first computer 11.1 is optionally also configured to compare the collected information with a predetermined growth curve. For example, the at least one growth parameter of the recognized calf 2.i at one point in time can be compared with at least one reference growth parameter at a corresponding point in time of the predetermined growth curve. The predetermined growth curve may then be representative, for example, of an expected development in growth, such as a minimum expected development, of the at least one growth parameter of a healthy calf in time. The first computer 11.1 may then be configured to generate an attention signal when the collected information deviates from the predetermined growth curve to the extent that the deviation meets a predetermined criterion. Optionally, a predetermined criterion is that the deviation mentioned is greater than an acceptable difference between collected information and the growth curve at a corresponding point in time, such as 5%, 10%, 15%, 20% or 25%, and the deviation is a negative deviation and hence reflects a lag in the development of the calf 2.i.

The attention signal is optionally a digital notification about a predetermined criterion being met, which can be observed via a human interface such as a computer, tablet or mobile phone (not represented, but conventional). The attention signal optionally comprises the identity of the recognized calf 2.i. In this example, the identification unit 13 is so disposed that the calf 2.i which is identified is also recognized in the 3D image and vice versa. The camera system 5 is further so configured that the area 7 comprises only a part of the total area (the space in the pen 3) where the calves can be. The area 7 in this example has such dimensions that A calves may be in it at the same time. ‘A’ is then in the range of 1-10,000, preferably 1-1,000, more preferably 1-100, and still more preferably 1-50. In this example N is less than or equal to A. The area 7 has a surface area which is in the range of 10-400 m², in particular in the range of 15-100 m². The signal processing unit 9 and the first computer 11.1 are in a cloud 17, such as virtually on a distant server. This, however, is entirely optional and indicated with a dotted line.

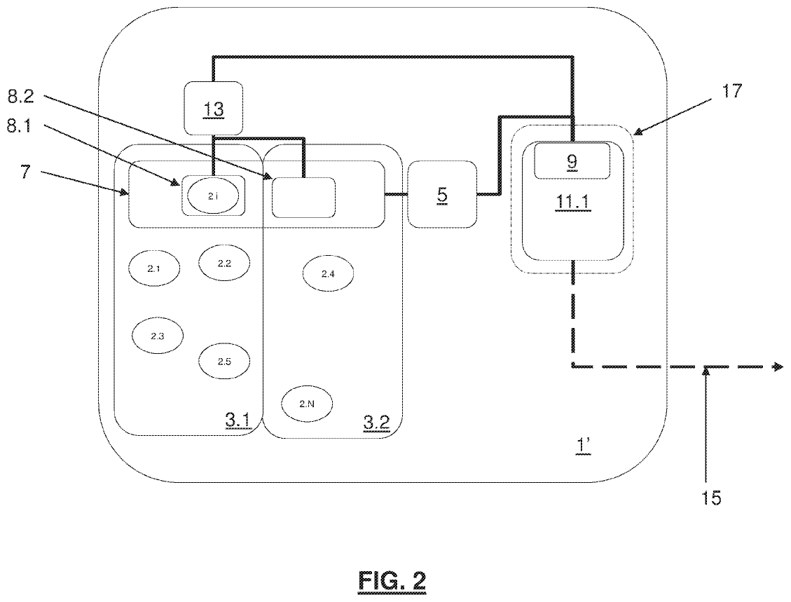

FIG. 2 shows a further schematic system 1′ for monitoring the growth of calves 2.i. In FIG. 1 and FIG. 2, mutually corresponding parts are provided with a same reference numeral. In the following, only the differences of the system 1′ of FIG. 2 with respect to the system 1 of FIG. 1 will be discussed. In this example, the camera system 5 is so disposed that respectively areas (spaces) of a multiplicity of pens 3.1, 3.2 are covered by the area 7. The multiplicity of pens 3.1, 3.2 in this example amounts to two pens, but this may be more pens. The signal processing unit 9 is configured to be able to recognize calves, according to a first predetermined algorithm, in at least each of the pens 3.1, 3.2, as at a first position 8.1 in the first pen 3.1 and a second position 8.2 in the second pen 3.2. In this example the identification unit 13 is configured to determine an identity of the calf 2.i which has been recognized by the signal processing unit 9, when the animal is at the first position 8.1 or the second position 8.2.

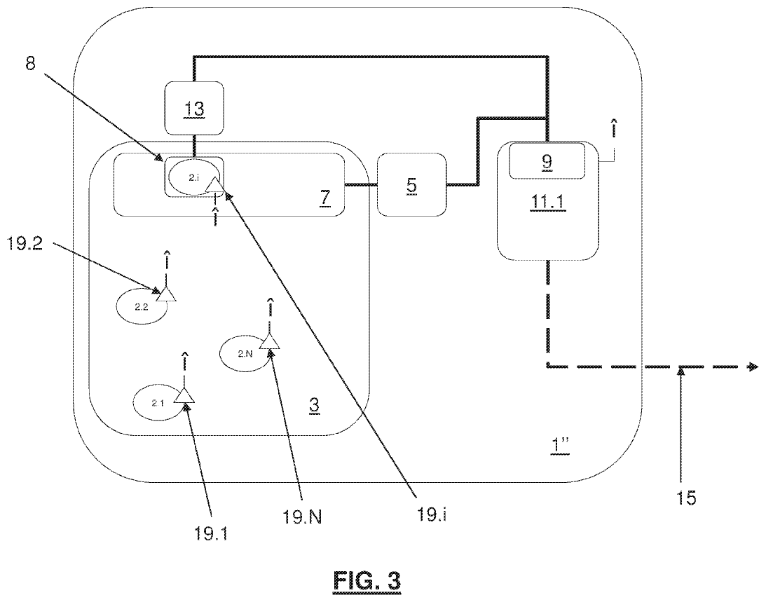

FIG. 3 shows a further schematic system 1″ for monitoring the growth of calves 2.i. In FIG. 1 and FIG. 3, mutually corresponding parts are provided with a same reference numeral. In the following, only the differences of the system 1″ of FIG. 3 with regard to the system 1 of FIG. 1 will be discussed. In this example, the system 1″ furthermore includes behavior sensors 19.i. A behavior sensor is, for example, a motion sensor to detect movements of the animal.

Each calf 2.i carries one of the behavior sensors 19.i for determining the behavior of the respective calf. The behavior comprises, for example, a condition which the calf 2.i is in, such as walking, lying, eating and/or ruminating, and/or information about when particular conditions occur, spread in time. The first computer 11.1 is further configured for, in use, utilizing the information about the behavior of the calf 2.i obtained with the behavior sensor 19.i in comparing the collected information with the predetermined growth curve. The behavior sensors 19.i and the first computer 11.1 are configured to be communicatively connected via, for example, a wireless network i. In this example, the first computer 11.1 is not in the cloud 17 (represented in FIG. 1), but may be so. The first computer 11.1 is configured for, in use, utilizing the information about the behavior of the calf 2.i obtained with the behavior sensor 19.i to adjust the predetermined criterion, for example, such that, in use, underweight of the calf 2.i is detected at a smaller deviation when it already appears earlier from the determined behavior that the calf eats relatively little, or less often, and vice versa. This could be achieved by lowering the earlier-mentioned acceptable difference when it is already noticed from the behavior of the calf 21 that the calf eats relatively little or less often.

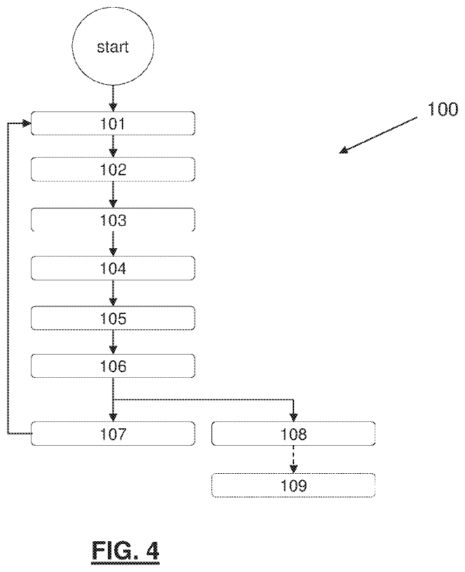

FIG. 4 shows a schematic method 100 for monitoring the growth of calves. The systems 1, 1′, 1″ of FIGS. 1, 2, 3 are each configured for carrying out the method steps of FIG. 4.

In a first step 101, the multiplicity of calves 2.i are gathered together in the at least one collective pen 3 (FIGS. 1, 3), 3.1 (FIG. 2), 3.2 (FIG. 2) in which the calves 2.i can move freely. The first step 101 leads to a second step 102.

In the second step 102, a 3D image of an area 7 is obtained within the at least one pen 3, 3.1, 3.2 with the aid of the camera system 5, while the calves can be within the area. The second step 102 leads to a third step 103.

In the third step 103, information about the 3D image of the area 7 is supplied to the signal processing unit 9. The third step 103 leads to a fourth step 104.

In the fourth step 104, with the signal processing unit 9, according to the first predetermined algorithm, the calf 2.i is recognized in the 3D image. The fourth step 104 leads to a fifth step 105.

In the fifth step 105, the identity of the calf 2.i in the 3D image is determined. The calf 2.i, which is recognized in the 3D image is the same calf that is identified, and vice versa. The fifth step 105 leads to a sixth step 106.

In the sixth step 106, with the signal processing unit 9, on the basis of a 3D image obtained and supplied in the third step 103, of the calf 2.i recognized in the fourth step 104, within the 3D image of the area 7, according to the second predetermined algorithm, the at least one growth parameter is estimated. The sixth step 106 leads to a seventh step 107 and an eighth step 108.

In the seventh step 107 it is determined that the recognized and identified calf 2.i has reappeared in the 3D image of the area 7 again. The seventh step 107 leads to the first step 101.

In the eighth step 108, with the aid of the first computer 11.1, the information obtained in the fourth step 104 through the seventh step 107 is collected to gain insight into the growth of the calf 2.i in time.

In this method 100, preferably with the first computer 11.1, the collected information can be compared with a predetermined growth curve. Preferably, the eighth step 108 leads to an optional ninth step 109.

In the optional step 109, with the first computer 11.1, an attention signal is generated when the collected information deviates from the growth curve when the deviation meets the predetermined criterion. It will be clear that the steps as described above do not necessarily need to take place in this same order. Also, other steps may take place.

In the case where each calf 2.i is provided with sensors 19.i for determining the behavior of each calf 2.i whose identity has been determined in the fifth step 105, information about the behavior of the calf 2.i obtained with the sensor 19.i can be used in comparing the information collected in the eighth step 108 with the predetermined growth curve. The information about the behavior of the calf 2.i can then be used to adjust the predetermined criterion. One predetermined criterion is, optionally, that the deviation in absolute terms is greater than an acceptable difference between collected information and the growth curve at a corresponding point in time, such as 5%, 10%, 15%, 20% or 25%, with the deviation being such that the information deviates negatively relative to the growth curve. Adjusting the predetermined criterion could be done, for example, by reducing the acceptable difference. For example, this may be done such that underweight of the calf 2.i is detected at a smaller deviation when it already appears earlier from the determined behavior that the calf 2.i eats relatively little or less often, and vice versa.

For the sake of the clarity and conciseness of the description, features are herein described as part of the same or of separate embodiments. It will be clear to those skilled in the art that embodiments comprising combinations of any or all of the features described also fall within the scope of protection of the invention. Within the purview of those skilled in the art, modifications are possible which are understood to be within the scope of the protection. For example, the calves, instead of being in a pen, can also be in a barn space where they can move freely. Other spaces than pens hence also fall within the framework of the invention. In the example given, the growth of an animal is monitored, which then involves determining a growth parameter and a growth curve. It is also possible, however, to monitor a development parameter of the animal and to compare it with an associated development curve. The development parameter can then, again, be a weight parameter, volume parameter or length parameter of the animal or of a part of the body of the animal as discussed before. The development curve can then again relate to the expected normal development of one or more development parameters in time. A growth curve is a development curve for animals still growing. A development curve, however, is a broader concept which can also relate to the entire lifespan of an animal or just to the period when animal is adult. In the latter case, the development curve which relates to a development parameter such as a weight parameter, volume parameter or length parameter of the animal will be practically constant in time. Only when the animal is relatively old may it be that, for example, a weight parameter or volume parameter decreases, for example because a body cell mass of the animal decreases. In the foregoing, a calf was taken as an example of an animal. However, other animals such as piglets and horses can be monitored with the same method and a same system as discussed hereinbefore.

1. A method for monitoring the development of animals, calves and piglets, over time, the method comprising:
a. bringing together a multiplicity of animals in at least one collective space, such as a pen or barn space, in which the animals can move freely;
b. obtaining a 3D image of an area which is at least for a part within the at least one space, with the aid of at least one 3D camera and/or a multiplicity of cameras such as a multiplicity of 2D cameras while the animals can be within the area;
c. supplying information about the 3D image to a signal processing unit;
d. with the signal processing unit, on the basis of the information about the 3D image supplied in step c., and according to a first predetermined algorithm, recognizing an animal in the 3D image;
e. determining the identity of the animal which has been or is recognized in step d.;
f. with the signal processing unit, on the basis of the information about the 3D image supplied in step c., and according to a second predetermined algorithm, at least estimating a condition parameter of the animal such as a weight, a volume and/or a length parameter of the animal recognized in step d.;
g. repeating steps d.-f. when the animal appears in the image again;
h. with the aid of a first computer, collecting the information obtained in steps d.-g. to gain insight into the development in time of the animal such as the growth in time of the animal.

2. The method according to claim 1, wherein the collected information is, with the first computer, compared with a predetermined development curve such as a growth curve, wherein with the first computer an attention signal is generated when the collected information deviates from the development curve, with the deviation meeting a predetermined criterion.

3. The method according to claim 2, wherein the predetermined criterion is chosen such that an attention signal is generated when the information of the animal collected over time deviates relative to the development curve, that the predetermined criterion is chosen such that an attention signal is generated when a growth of the animal lags behind the growth curve.

4. The method according to claim 2, wherein said attention signal comprises the identity determined in step e.

5. The method according to claim 1, wherein step e. is carried out with a reader, the animals each provided with a tag which comprises information about an identity of an animal and which can be read out wirelessly by the reader, while preferably the reader and the tags are of the RFID and/or UHF type.

6. The method according to claim 5, wherein the reader is so disposed that in step e. the identity of an animal is determined which is at such a position in the 3D image of the area that the animal in step d. is recognized in the 3D image of the area.

7. The method according to claim 1, wherein in step b. the area comprises only a part of the space where the animals can be.

8. The method according to claim 7, wherein the area has such dimensions that a multiplicity of animals can be in it at the same time, the area has a surface area which is preferably in the range of 10 400 m2, and/or that the area has such dimensions that A animals can be in it at the same time, with A being in the range of 1-10,000.

9. The method according to claim 7, wherein the area that is covered with the at least one 3D camera and/or the multiplicity of 2D cameras respectively comprises spaces of a multiplicity of pens.

10. The method according to claim 1, wherein the signal processing unit is part of the first computer, while optionally the signal processing unit and/or the first computer are in a cloud.

11. The method according to claim 3, wherein each animal is furthermore provided with at least one sensor for determining the behavior of the animal of step e., the behavior consisting in
a condition which the animal is in, such as walking, lying, eating and ruminating, and/or
information about when particular conditions occur, spread over time,
wherein the information about the behavior of the animal obtained with the at least one sensor is used in comparing the information collected in step h. with the predetermined development curve such as the growth curve.

12. The method according to claim 11, wherein the information about the behavior of the animal obtained with the at least one sensor is used to adjust the predetermined criterion, such that underweight of the animal is detected at a smaller deviation when it already appears earlier from the determined behavior that the animal eats relatively little or less often and vice versa.

13. A system for carrying out a method according to claim 1, wherein the system comprises the at least one space and the at least one 3D camera and/or the multiplicity of 2D cameras for obtaining the 3D image of the area as well as the signal processing unit which is configured for carrying out steps d. and f. and the first computer which is configured for carrying out step h.

14. The system according to claim 13, wherein the system further includes at least one identification unit such as a reader for carrying out step e., the reader is an RFID reader and/or UHF reader.

15. A system for monitoring the development in time of animals, calves and piglets, the system comprising at least one pen or barn space in which a multiplicity of animals can be brought together, at least one 3D camera and/or a multiplicity of 2D cameras for obtaining a 3D image of an area which is at least for a part within the at least one space where the animals can be, a signal processing unit for processing information about the 3D image, a first computer, and an identification unit, wherein the signal processing unit is configured for, according to a first predetermined algorithm, on the basis of the information about the 3D image, recognizing an animal in the 3D image, wherein the identification unit is configured to determine the identity of the animal which has been or is recognized by the signal processing unit, and wherein the signal processing unit is further configured for, on the basis of the information about the 3D image, according to a second predetermined algorithm, estimating at least one condition parameter such as weight, a volume and/or a length parameter of the recognized animal, wherein the first computer is configured for collecting information obtained about the condition parameter of the animal at different points over time to obtain insight into the development such as growth of the animal over time.

16. The system according to claim 15, wherein the first computer is configured to compare the collected information with a predetermined development growth curve, wherein the first computer is further configured for generating an attention signal when the collected information deviates from the development curve and wherein the deviation meets a predetermined criterion.

17. The system according to claim 16, wherein the first computer is so configured that an attention signal is generated when a growth of the animal lags behind the growth curve.

18. The system according to claim 17, wherein said attention signal comprises the identity determined with the identification unit.

19. The system according to claim 15, wherein the identification unit comprises a reader, wherein the system furthermore includes a multiplicity of tags, wherein the animals are each provided with one of the tags which each comprise information about an identity of an animal, wherein at least the identity of the animal can be wirelessly read from a tag by the reader, wherein preferably the reader and the multiplicity of tags are of the RFID or UHF type.

20. The system according to claim 19, wherein the identification unit so disposed that, in use, the identity of an animal is determined which is at such a position in the 3D image that this animal is recognized in the 3D image with the signal processing unit, in use.

21. The system according to claim 15, wherein the 3D camera and/or the multiplicity of 2D cameras are so configured and/or disposed that, in use, the area comprises only a part of the space which the animals can be in.

22. The system according to claim 21, wherein the area has such dimensions that a multiplicity of animals can be in it at the same time, wherein the area has a surface area which is in the range of 10 400 m2, and/or that the area has such dimensions that A animals can be in it at the same time, wherein A is in the range of 1-10,000.

23. The system according to claim 15, wherein the at least one 3D camera and/or the multiplicity of 2D cameras is so disposed that the area covers a multiplicity of pens.

24. The system according to claim 15, wherein the signal processing unit is part of the first computer, wherein the signal processing unit and/or the first computer are in a cloud.

25. The system according to at least claim 16, wherein the system furthermore includes sensors, wherein, in use, each animal is furthermore provided with at least one of the sensors for determining the behavior of the animal, the behavior consisting of
a condition, such as walking, lying, eating and/or ruminating, which the animal is in, and/or
information about when particular conditions occur, spread over time,
wherein the first computer is further configured for, in use, utilizing the information about the behavior of the animal obtained with the sensors in comparing the collected information with the predetermined development growth curve.

26. The system according to claim 25, wherein the first computer is configured for, in use, utilizing the information about the behavior of the animal obtained with the sensors to adjust the underweight of the animal at a smaller deviation when it already appears earlier from the determined behavior that the animal eats relatively little or less often and vice versa.
